(19) United States
(12) Patent Application Publication
(10) Pub. No.: US 2016/0247598 A1
(43) Pub. Date: Aug. 25, 2016

(54) INSULATED WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Tsuyoshi NONAKA, Yokkaichi (JP)

(73) Assignees: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(21) Appl. No.: 15/032,262

(22) PCT Filed: Oct. 15, 2014
(86) PCT No.: PCT/JP2014/077370

§ 371 Date: Apr. 26, 2016

(30) Foreign Application Priority Data
Nov. 5, 2013 (JP) 2013-229340

(51) Int. Cl. H01B 3/46

(52) U.S. Cl. CPC H01B 3/46

(57) ABSTRACT

An insulated wire that includes an insulating layer containing crosslinked silicone rubber and that has good wear resistance and good gasoline resistance is provided. In an insulated wire obtained by covering a conductor with an insulating layer containing crosslinked silicone rubber, the crosslinked silicone rubber has an inter-crosslinking molecular weight of 2000 or less. It is preferable that the insulating layer has a Shore A hardness of at least 50 as measured in accordance with JIS K6253. The insulating layer may further contain calcium carbonate powder, magnesium oxide powder, magnesium hydroxide powder, and the like.

### TECHNICAL FIELD

The present disclosure relates to an insulated wire, and more specifically to an insulated wire to be preferably used in a vehicle such as an automobile.

### BACKGROUND ART

As insulating materials for insulated wires to be used in vehicles such as automobiles, materials containing halogen, such as polyvinyl chloride resins and compounds into which a halogen flame retardant is blended, are used. When the insulating materials containing halogen are disposed of by being incinerated, corrosive gas is generated in some cases. Therefore, from the viewpoint of environmental protection and the like, attempts have been made to use insulating materials containing no halogen.

Patent Document 1 states that a non-halogen insulating material obtained by blending aluminum hydroxide with uncrosslinked silicone rubber is used as the insulating material for an insulated wire, for example.

### CITATION LIST

### Patent Documents

Patent Document 1: Japanese Patent No. 3555101

### SUMMARY

If a rubber material (silicone rubber) is used as the insulating material for an insulated wire, problems arise in that an insulating layer is softer and is more easily worn off compared with a case where a polyvinyl chloride resin is used, for example. Also, there is a problem in that silicone rubber is easily swelled with gasoline.

The problem to be solved of the present disclosure is to provide an insulated wire that includes an insulating layer containing crosslinked silicone rubber and that has good wear resistance and good gasoline resistance.

In order to solve the foregoing problems, an insulated wire according to the present disclosure is an insulated wire obtained by covering a conductor with an insulating layer containing crosslinked silicone rubber, the crosslinked silicone rubber having an inter-crosslinking molecular weight of 2000 or less.

In this case, it is preferable that the insulating layer has a Shore A hardness of at least 50 as measured in accordance with JIS K6253.

The insulating layer may contain at least one of calcium carbonate powder, magnesium oxide powder, and magnesium hydroxide powder in an amount of 0.1 to 20 parts by mass with respect to 100 parts by mass of the crosslinked silicone rubber. Alternatively, the insulating layer may contain none of calcium carbonate powder, magnesium oxide powder, and magnesium hydroxide powder.

### Advantageous Effects

With the insulated wire according to the present disclosure, the crosslinked silicone rubber contained in the insulating layer has an inter-crosslinking molecular weight of 2000 or less, and therefore, good wear resistance and good gasoline resistance are obtained.

In this case, when the insulating layer has a Shore A hardness of at least 50 as measured in accordance with JIS K6253, particularly good wear resistance is obtained.

When the insulating layer contains at least one of calcium carbonate powder, magnesium oxide powder, and magnesium hydroxide powder in a specific amount, wear resistance and gasoline resistance can be improved.

On the other hand, when the insulating layer contains none of calcium carbonate powder, magnesium oxide powder, and magnesium hydroxide powder, the cost can be reduced. Also in this case, good wear resistance and good gasoline resistance are obtained.

### DETAILED DESCRIPTION OF EMBODIMENTS

Next, an embodiment of the present disclosure will be described in detail.

An insulated wire according to the present disclosure includes a conductor and an insulating layer that covers the conductor. The insulating layer contains crosslinked silicone rubber.

The insulating layer is made of a rubber composition for an insulating layer that contains uncrosslinked silicone rubber. As the uncrosslinked silicone rubber, a millable type (heat-crosslinking type), which forms an elastic body by being heated and crosslinked after being kneaded with a crosslinking agent, or a liquid rubber type, which is in a liquid form before being crosslinked, may be used. There are two types of the liquid rubber type silicone rubber: one is a room temperature crosslinking type (RTV), which can be crosslinked at near room temperature; and the other is a low temperature crosslinking type (LTV), which is crosslinked by being heated at near 100° C. after mixing.

The millable type silicone rubber is preferable as the uncrosslinked silicone rubber. Since the millabe type silicone rubber is crosslinked at a relatively high temperature of 180° C. or higher and has a good stability, there is an advantage in that mixing is easily performed during kneading, and the workability is good. In contrast, since the liquid rubber type silicone rubber is generally crosslinked at a low temperature of about 120° C. and has a low stability, it is necessary to suppress heat generation to a low level during kneading, and the workability is slightly worse from the viewpoint of temperature control and the like. A millable type silicone rubber that is commercially available as a rubber compound obtained by blending linear organopolysiloxane serving as a principal material (raw rubber) with a reinforcing agent, a filler (extending agent), a dispersion accelerator, other additives, and the like may be used.

The inter-crosslinking molecular weight of the crosslinked silicone rubber is set to 2000 or less. This makes it possible to improve the gasoline resistance. The swelling of the crosslinked silicone rubber with gasoline is caused by the infiltration of gasoline (liquid) into three-dimensional spaces (meshes) in the crosslinked silicone rubber. It is inferred that since the crosslinking density is increased and the volume of the meshes (openings) is reduced by reducing the inter-crosslinking molecular weight, the infiltration of gasoline is suppressed, and thus the swelling with gasoline is suppressed. From this viewpoint, in the present disclosure, the inter-crosslinking molecular weight of the crosslinked silicone rubber is set to 2000 or less. From the viewpoint of obtaining better gasoline resistance, the inter-crosslinking molecular weight of the crosslinked silicone rubber is more preferably 1900 or less, and still more preferably 1800 or less.

The inter-crosslinking molecular weight of the crosslinked silicone rubber can be reduced by increasing the blend amount of the crosslinking agent, or increasing a crosslinking temperature, for example.

The inter-crosslinking molecular weight can be calculated from the density and storage modulus of the crosslinked silicone rubber using a calculation equation below. The value of the density (g/cm³) is measured at room temperature (23° C.), and the value of the storage modulus (MPa) is measured at 23° C. with a solid viscoelasticity measurement apparatus.

Inter-crosslinking molecular weight=(3×density×gas constant×absolute temperature)/storage modulus Equation 1

In the present disclosure, since the inter-crosslinking molecular weight of the crosslinked silicone rubber is 2000 or less, the crosslinking density is high, and thus the wear resistance can also be improved. Accordingly, the insulating layer may contain none of calcium carbonate powder, magnesium oxide powder, and magnesium hydroxide powder.

In the present disclosure, the insulating layer may also contain at least one of the calcium carbonate powder, the magnesium oxide powder, and the magnesium hydroxide powder. In this case, the wear resistance can be improved. These powders are effective in improving the strength of the insulating layer containing the crosslinked silicone rubber. The wear resistance can be improved by improving the strength of the insulating layer. That is, when these powders, which are more unlikely to be ground than the crosslinked silicone rubber, are blended, the strength of the insulating layer is improved, and thus the wear resistance is improved. It is inferred that in this case, the wear of the insulating layer is caused by these powders falling off from the insulating layer.

These powders are also effective in improving the gasoline resistance of the insulating layer containing the crosslinked silicone rubber. Silicone rubber is easily swelled when coming into contact with gasoline, and is inferior in gasoline resistance, but these powders can be used to improve the gasoline resistance. It is inferred that this is because these powders suppress the infiltration of gasoline into the silicone rubber, and thus the swelling of the silicone rubber with gasoline is suppressed.

From the viewpoint of suppressing the reduction in cold resistance, and suppressing the reduction in heat resistance, for example, the content of these powders is preferably 20 parts by mass or less with respect to 100 parts by mass of the crosslinked silicone rubber, more preferably 15 parts by mass or less, and still more preferably 10 parts by mass or less. On the other hand, from the viewpoint in which the wear resistance and the gasoline resistance can be improved, for example, the contnet of these powders is preferably 0.1 parts by mass or more with respect to 100 parts by mass of the crosslinked silicone rubber, more preferably 0.2 parts by mass or more, and still more preferably 0.5 parts by mass or more.

From the viewpoint of improving the handle ability and reducing a time for which the powder is mixed into the silicone rubber, for example, the average particle diameter of the calcium carbonate powder, the magnesium oxide powder, or the magnesium hydroxide powder is preferably 0.01 μm or more, and more preferably 0.05 μm or more. Moreover, from the viewpoint in which favorable cold resistance, favorable wear resistance, and favorable gasoline resistance are easily obtained, the average particle diameter of these powders is preferably 5.0 μm or less, and more preferably 4.0 μm or less. If the average particle diameter is small, the insulating layer has good surface smoothness, the powder is unlikely to fall off when frictional force is applied, and thus the wear resistance is improved. In addition, if the average particle diameter is small, the dispersibility is improved, and thus the wear resistance and the cold resistance are improved. It should be noted that the average particle diameter can be determined as a cumulative weight average value D₅₀ (or a median diameter) with a particle size distribution measurement apparatus using a laser beam diffraction method or the like.

From the viewpoint of suppressing aggregation and improving the affinity with silicone rubber, for example, a surface treatment may be performed on the calcium carbonate powder, the magnesium oxide powder, and the magnesium hydroxide powder. Examples of a surface treating agent include a homopolymer of α-olefin such as 1-heptene, 1-octene, 1-nonene, or 1-decene, a mutual copolymer thereof, a mixture thereof, fatty acid, rosin acid, and a silane coupling agent.

The above-mentioned surface treating agent may be modified. As a modifying agent, unsaturated carboxylic acid and a derivative thereof can be used. Specific examples of the unsaturated carboxylic acid include maleic acid and fumaric acid. Examples of the derivative of unsaturated carboxylic acid include maleic anhydride (MAH), maleic monoester, and maleic diester. Of these, maleic acid, maleic anhydride and the like are preferable. It should be noted that these modifying agents for a surface treating agent may be used alone or in a combination of two or more.

Examples of a method for introducing acid into a surface treating agent include a grafting method and a direct method. The acid-modified amount is 0.1 to 20 mass % of the surface treating agent, preferably 0.2 to 10 mass %, and more preferably 0.2 to 5 mass %.

There is no particular limitation on a surface treating method using a surface treating agent. The surface treatment may be performed on the above-mentioned powder or may be simultaneously performed during the synthesis of the above-mentioned powder. As the treating method, a wet treatment using a solvent or a dry treatment using no solvent may be performed. Aliphatic solvents such as pentane, hexane, and heptane, and aromatic solvents such as benzene, toluene, and xylene can be preferably used in the wet treatment. Moreover, when an insulating layer composition is prepared, the surface treating agent may be simultaneously kneaded with materials such as other raw materials of rubber.

There are two types of the calcium carbonate powder: one is synthetic calcium carbonate made through chemical reactions; and the other is heavy calcium carbonate made through the pulverization of limestone. The synthetic calcium carbonate on which the surface treatment using the surface treating agent such as fatty acid, rosin acid, and a silane coupling agent is performed can be used as fine particles having a primary particle diameter of submicrometer or less (about several tens of nanometers). The average particle diameter of the fine particles subjected to the surface treatment is expressed as a primary particle diameter. The primary particle diameter can be measured by electron microscopy. The heavy calcium carbonate is a pulverized product, and the surface treatment using fatty acid or the like is not necessarily performed thereon. The heavy calcium carbonate can be used as particles having an average particle diameter of several hundreds of nanometers to about 1 μm. Both the synthetic calcium carbonate and the heavy calcium carbonate can be used as the calcium carbonate powder.

Specific examples of the calcium carbonate powder include Hakuenka CC (average particle diameter=0.05 μm), Hakuenka CCR (average particle diameter=0.08 μm), Hakuenka DD (average particle diameter=0.05 μm), Vigot 10 (average particle diameter=0.10 μm), Vigot 15 (average particle diameter=0.15 μm), and Hakuenka U (average particle diameter=0.04 μm), which are available from Shiraishi Calcium Kaisha, Ltd.

Specific examples of the magnesium oxide include UC95S (average particle diameter=3.1 μm), UC95M (average particle diameter=3.0 μm), and UC95H (average particle diameter=3.3 μm), which are available from Ube Material Industries, Ltd.

As the magnesium hydroxide, synthetic magnesium hydroxide that is synthesized from sea water with a crystal growth method or synthesized through the reaction of magnesium chloride and calcium hydroxide, for example, natural magnesium hydroxide obtained through the pulverization of naturally occurring minerals, and the like can be used. Specific examples of the magnesium hydroxide serving as the above-mentioned filler include UD-650-1 (average particle diameter=3.5 μm) and UD653 (average particle diameter=3.5 μm), which are available from Ube Material Industries, Ltd.

It is preferable that the insulating layer has a Shore A hardness of at least 50 as measured in accordance with JIS K6253. The above-mentioned Shore A hardness is more perferably at least 55, and still more preferably at least 60. The hardness of the insulating layer can be increased by increasing the hardness of the crosslinked silicone rubber contained in the insulating layer. When the crosslinked silicone rubber has a relatively high hardness, even in the case where the crosslinked silicone rubber contains none of the calcium carbonate powder, the magnesium oxide powder, and the magnesium hydroxide powder, or contains the powders in a relatively small amount, good wear resistance can be secured. In order to increase the hardness of the crosslinked silicone rubber, it is possible to employ a method in which millable type uncrosslinked silicone rubber is used, uncrosslinked silicone rubber having a high hardness is used, a reinforcing agent is blended into the silicone rubber, or the crosslinking density is increased, for example. One example of the reinforcing agent is silica. Reinforcing silica is particularly preferable. In order to increase the crosslinking density, the blend amount of the crosslinking agent is increased, for example.

The crosslinking agent can be selected as appropriate depending on the type of the uncrosslinked silicone rubber, crosslinking condition, and the like. Examples of the crosslinking agent include radical generators such as organic peroxides, and compounds such as metal soap, amine, thiol, thiocarbamate, and organic carboxylic acid. From the viewpoint of improving the crosslinking speed, the organic peroxides are preferable as the crosslinking agent.

Examples of the organic peroxides include dialkyl peroxides such as dihexyl peroxide, dicumyl peroxide, t-butyl cumyl peroxide, and 2,5-dimethyl-2,5-bis(t-butylperoxy)hexane, and peroxyketals such as n-butyl 4,4-di(t-butylperoxide)valerate.

The blend amount of the crosslinking agent can be determined as appropriate. It is preferable that the blend amount of the crosslinking agent is in a range of 0.01 to 10 mass % with respect to the total amount of the uncrosslinked silicone rubber and the crosslinking agent, for example.

The blend amount of the crosslinking agent can be determined depending on the hardness of the uncrosslinked silicone rubber. If the uncrosslinked silicone rubber has a Shore A hardness of less than 40, it is preferable that the blend amount of the crosslinking agent is in a range of 0.5 to 3 mass % with respect to the total amount of the uncrosslinked silicone rubber and the crosslinking agent. If the uncrosslinked silicone rubber has a Shore A hardness of at least 40 and less than 50, it is preferable that the blend amount of the crosslinking agent is in a range of 0.5 to 3 mass %. If the uncrosslinked silicone rubber has a Shore A hardness of at least 50 and less than 60, it is preferable that the blend amount of the crosslinking agent is in a range of 0.5 to 5 mass %. If the uncrosslinked silicone rubber has a Shore A hardness of at least 60 and less than 70, it is preferable that the blend amount of the crosslinking agent is in a range of 0.5 to 5 mass %. If the uncrosslinked silicone rubber has a Shore A hardness of at least 70 and less than 80, it is preferable that the blend amount of the crosslinking agent is in a range of 0.5 to 5 mass %. If the uncrosslinked silicone rubber has a Shore A hardness of at least 80, it is preferable that the blend amount of the crosslinking agent is in a range of 0.5 to 5 mass %.

The insulating layer may or need not contain various additives other than the crosslinked silicone rubber as long as the characteristics of the insulating layer is not deteriorated. Examples of such additives include common additives to be used in an insulating layer of an insulated wire. Specific examples thereof include a flame retardant, a crosslinking agent, a filler, an antioxidant, an age resistor, and pigment.

The insulated wire according to the present disclosure can be manufactured by forming an insulating layer around a conductor by extrusion molding. In this case, a rubber composition for an insulating layer that contains the uncrosslinked silicone rubber is prepared, and then the rubber composition is subjected to extrusion molding at a predetermined temperature. The uncrosslinked silicone rubber is crosslinked depending on the molding temperature and the molding time. After that, secondary vulcanization (secondary crosslinking) may be performed in order to complete the crosslinking of the silicone rubber. The secondary vulcanization is performed by heating with an oven, for example. The secondary vulcanization is performed for the purpose of not only completing the crosslinking of the silicone rubber but also thermally stabilizing the characteristics of the silicone rubber by providing a heat history to the silicone rubber, and removing residue produced in the peroxide-crosslinking, for example.

The secondary vulcanization is performed at a predetermined temperature for a predetermined period of time. If the secondary vulcanization is performed, the number of steps correspondingly increases, resulting in an increase in cost. Therefore, from the viewpoint of the cost, it is preferable that the secondary vulcanization can be omitted. For this purpose, it is necessary to complete the vulcanization to a desired level in a primary vulcanization (extrusion molding). In this case, the rate of change in the inter-crosslinking molecular weight needs to be small between before and after the secondary vulcanization. Specifically, the rate of change is preferably 20% or less, more preferably 15% or less, and still more preferably 10% or less.

In order to reduce the rate of change in the inter-crosslinking molecular weight, it is sufficient that the degree of crosslinking in the primary vulcanization is increased by increasing the blend amount of the crosslinking agent or increasing the content of functional groups having high reactivity such as a vinyl group and an acrylic group.

The insulated wire according to the present disclosure can also be manufactured by coating a conductor with a rubber composition for an insulating layer to form a coating layer and by crosslinking uncrosslinked rubber in the coating layer using a crosslinking means such as heating.

The rubber composition for an insulating layer can be prepared by kneading the uncrosslinked silicone rubber with the calcium carbonate powder, the magnesium oxide powder, the magnesium hydroxide powder, the crosslinking agent, and the like, which are optionally blended. An ordinary kneading machine such as a Banbury mixer, a pressurizing kneader, a kneading extruder, a twin-screw kneading extruder, or a roll can be used to knead the components of the rubber composition.

A wire extrusion molding machine used to manufacture ordinary insulated wires can be used to subject the rubber composition for an insulating layer to the extrusion molding. As the conductor, a conductor used in ordinary insulated wires can be used. Examples of the conductor include a single wire conductor and a twisted wire conductor that are made of a copper-based material or an aluminum-based material. The diameter of the conductor and the thickness of the insulating layer are not particularly limited and can be determined as appropriate depending on the application of the insulated wire.

While the embodiment of the present disclosure has been described in detail, the present disclosure is not limited to the above-mentioned embodiment, and various modifications can be made without departing from the gist of the present disclosure. For example, although the insulated wire of the above-mentioned embodiment includes an insulating layer constituted by a single layer, the insulated wire according to the present disclosure may also include an insulating layer constituted by two or more layers.

The insulated wire according to the present disclosure can be used as an insulated wire to be used in automobiles and electric and electronic apparatuses.

### Examples

Hereinafter, working examples and comparative examples of the present disclosure will be described.

### Working Examples 1 to 8

A rubber composition for an insulating layer containing uncrosslinked silicone rubber was prepared by mixing components such that the blend composition shown in Table 1 was obtained. Then, the rubber composition for an insulating layer was extruded using an extrusion molding machine to cover the outer circumference of a conductor (cross-sectional area of 0.5 mm²) constituted by an annealed copper stranded wire obtained by twisting seven annealed copper wires with a thickness of 0.2 mm (180° C.×5 minutes). Next, heat treatment was performed on the coating layer under a condition of 200° C.×4 hours to complete the crosslinking of the silicone rubber in the coating layer. Accordingly, insulated wires of Working Examples 1 to 8 were obtained.

### Comparative Examples 1 to 7

A composition for an insulating layer containing uncrosslinked silicone rubber was prepared by mixing components such that the blend composition shown in Table 2 was obtained. Then, insulated wires of Comparative Examples 1 to 7 were obtained in the same manner as in the working examples.

The insulated wires of Working Examples 1 to 8 and Comparative Examples 1 to 7 were subjected to a cold resistance test, a wear resistance test, and a gasoline resistance test, and evaluated. In addition, the Shore A hardness and the inter-crosslinking molecular weight of the insulating layers of these insulated wires were measured. The results are collectively shown in Table 1 and Table 2. It should be noted that the compositions, test methods, and evaluations shown in Table 1 and Table 2 are as follows.

### Components in Table 1 and Table 2

Silicone rubber 1: R401-50 (Hardness 50, Type-A durometer; the same applies hereinafter), available from Asahi Kasei Corporation
Silicone rubber 2: R401-60 (Hardness 60), available from Asahi Kasei Corporation
Silicone rubber 3: R401-70 (Hardness 70), available from Asahi Kasei Corporation
Silicone rubber 4: R401-80 (Hardness 80), available from Asahi Kasei Corporation
Silicone rubber 5: R401-40 (Hardness 40), available from Asahi Kasei Corporation
Silicone rubber 6: R401-30 (Hardness 30), available from Asahi Kasei Corporation
Silicone rubber 7: R401-20 (Hardness 20), available from Asahi Kasei Corporation
Silicone rubber 8: SH0030U (Hardness 30), available from KCC Corporation
Vigot 15: Calcium carbonate powder (average particle diameter=0.15 μm), available from Shiraishi Calcium Kaisha, Ltd.
UC95H: Magnesium oxide powder (average particle diameter=3.3 μm), available from Ube Material Industries, Ltd.
Crosslinking agent: Perhexyl D (di-t-hexyl peroxide), available from Nippon Oil & Fats Co., Ltd.

### Cold Resistance Test Method

The cold resistance test was performed in accordance with JIS C3005. Specifically, the manufactured insulated wire was cut to a length of 38 mm and used as a test piece. This test piece was attached to a cold resistance test machine, cooled to a predetermined temperature, and hit with a hitting tool. After that, the state of the test piece after hitting was observed. Five test pieces were used, and a temperature at which all of the five test pieces were broken was determined as a cold resistant temperature.

### Wear Resistance Test Method

The test was performed using a blade reciprocating method in accordance with the standard “JASO D618” of Society of Automotive Engineers of Japan. Specifically, the insulated wires of the working examples and comparative examples were cut to a length of 750 mm and used as a test piece. A blade was reciprocated on the coating material (insulating layer) of the test piece in a length of 10 mm or more at a speed of 50 times per minute in the axial direction at room temperature of 23±5° C., and the number of reciprocations was counted until the blade reached the conductor. In this case, the load applied to the blade was set to 7 N. If the number of reciprocations was 200 or more, the evaluation was “Good” (acceptable), and if the number of reciprocations was less than 200, the evaluation was “Poor” (not acceptable). If the number of reciprocations was 300 or more, the evaluation was “Excellent”, which was particularly good.

### Gasoline Resistance Test Method

The gasoline resistance test was performed in accordance with Method 2 of ISO 6722 (2011). Specifically, the manufactured insulated wire was cut to a length of 600 mm and used as a test piece. The test piece was immersed in liquid C according to ISO 1817 at 23° C. for 20 hours. If the maximum rate of change in the outer diameter of the wire was 15% or less, the evaluation was “Good”. If the maximum rate of change was 10% or less, the evaluation was “Excellent”. If the maximum rate of change was more than 15%, the evaluation was “Poor”.

### Hardness of Insulating Layer

The insulated wire, which was cut to a length of 10 cm, was fixed, and a durometer was pressed against the insulating layer from outside to measure the hardness of the insulating layer. The Shore A hardness, which is measured in a spring type hardness test using a type-A durometer, was measured in accordance with JIS K6253.

### Inter-Crosslinking Molecular Weight

A sample of the crosslinked silicone rubber constituted by the insulating layer obtained by removing the conductor from the insulated wire was used to determine the density and storage modulus, and the inter-crosslinking molecular weight was calculated using the calculation equation below. The value of the density (g/cm³) was measured at room temperature (23° C.), and the value of the storage modulus (MPa) was measured at 23° C. with a solid viscoelasticity measurement apparatus.

Inter-crosslinking molecular weight=(3×density×gas constant×absolute temperature)/storage modulus Equation 2

TABLE 1

| | Work. Ex. 1 | Work. Ex. 2 | Work. Ex. 3 | Work. Ex. 4 | Work. Ex. 5 | Work. Ex. 6 | Work. Ex. 7 | Work. Ex. 8 |
|---|---|---|---|---|---|---|---|---|
| Silicone rubber 5 | | | | | | | | 100 |
| (R401-40) | | | | | | | | |
| Silicone rubber 1 | 100 | 100 | | | | | | |
| (R401-50) | | | | | | | | |
| Silicone rubber 2 | | | 100 | | | | 100 | |
| (R401-60) | | | | | | | | |
| Silicone rubber 3 | | | | 100 | | 100 | | |
| (R401-70) | | | | | | | | |
| Silicone rubber 4 | | | | | 100 | | | |
| (R401-80) | | | | | | | | |
| Vigot 15 | 10 | | | | | | 5 | 20 |
| UC95H | | | | | | 5 | | |
| Crosslinking agent | 0.5 | 5.0 | 1.0 | 0.5 | 1.0 | 0.5 | 1.0 | 5.0 |
| (Perhexyl D) | | | | | | | | |
| Hardness of | 52 | 62 | 59 | 71 | 82 | 73 | 63 | 48 |
| insulation layer | | | | | | | | |
| (Shore A) | | | | | | | | |
| Inter crosslinking | 1900 | 1200 | 1500 | 1400 | 900 | 1300 | 1400 | 1900 |
| molecular weight | | | | | | | | |
| Cold resistance (° C.) | −35 | −35 | −35 | −35 | −25 | −30 | −30 | −30 |
| Wearability | Excellent | Good | Good | Good | Excellent | Excellent | Excellent | Excellent |
| Gasoline resistance | Excellent | Excellent | Good | Good | Excellent | Excellent | Excellent | Excellent |

TABLE 2

| | Comp. Ex. 1 | Comp. Ex. 2 | Comp. Ex. 3 | Comp. Ex. 4 | Comp. Ex. 5 | Comp. Ex. 6 | Comp. Ex. 7 |
|---|---|---|---|---|---|---|---|
| Silicone rubber 5 | 100 | | | | | 100 | |
| (R401-40) | | | | | | | |
| Silicone rubber 6 | | 100 | | | | | 100 |
| (R401-30) | | | | | | | |
| Silicone rubber 7 | | | 100 | | 100 | | |
| (R401-20) | | | | | | | |
| Silicone rubber 8 | | | | | | | |
| (SH0030U) | | | | 100 | | | |
| Crosslinking agent | 0.5 | 1.0 | 0.5 | 0.5 | 1.0 | 1.0 | 0.5 |
| (Perhexyl D) | | | | | | | |
| Hardness of | | | | | | | |
| insulation layer | 39 | 31 | 19 | 32 | 20 | 42 | 29 |
| (Shore A) | | | | | | | |
| Inter crosslinking | 2200 | 2300 | 3500 | 3200 | 3100 | 2100 | 2900 |
| molecular weight | | | | | | | |
| Cold resistance (° C.) | −35 | −35 | −40 | −40 | −40 | −35 | −40 |
| Wearability | Poor | Poor | Poor | Poor | Poor | Poor | Poor |
| Gasoline resistance | Poor | Poor | Poor | Poor | Poor | Poor | Poor |

It is found from the results from the working examples and comparative examples that when the inter-crosslinking molecular weight of the crosslinked silicone rubber was 2000 or less, satisfying wear resistance and satisfying gasoline resistance were obtained. It is also found that with the working examples, both the wear resistance and the gasoline resistance could be achieved. It is also found that with the working examples, excellent cold resistance could be obtained.

It is found from the results from Working Examples 1 and 6 to 8 that when the calcium carbonate powder or the magnesium oxide powder was added, the wear resistance and the gasoline resistance were improved.

While the embodiment of the present disclosure has been described in detail, the invention is not limited to the above-mentioned embodiment, and various modifications can be made without departing from the gist of the present disclosure. Furthermore, the above description is merely illustrative of the inventive concept and are not intended to limit the scope thereof.

1. An insulated wire comprising: a conductor covered with an insulating layer containing crosslinked silicone rubber,
the crosslinked silicone rubber having an inter-crosslinking molecular weight of 2000 or less.

2. The insulated wire according to claim 1, wherein the insulating layer has a Shore A hardness of at least 50 as measured in accordance with JIS K6253.

3. The insulated wire according to claim 1, wherein the insulating layer contains at least one of calcium carbonate powder, magnesium oxide powder, and magnesium hydroxide powder in an amount of 0.1 to 20 parts by mass with respect to 100 parts by mass of the crosslinked silicone rubber.

4. The insulated wire according to claim 1, wherein the insulating layer contains none of calcium carbonate powder, magnesium oxide powder, and magnesium hydroxide powder.

5. The insulated wire according to claim 2, wherein the insulating layer contains at least one of calcium carbonate powder, magnesium oxide powder, and magnesium hydroxide powder in an amount of 0.1 to 20 parts by mass with respect to 100 parts by mass of the crosslinked silicone rubber.

6. The insulated wire according to claim 2, wherein the insulating layer contains none of calcium carbonate powder, magnesium oxide powder, and magnesium hydroxide powder.
